(19) United States
(12) Patent Application Publication
(10) Pub. No.: US 2026/0175169 A1
(43) Pub. Date: Jun. 25, 2026

(54) WEARABLE CO2 ADSORPTION AND DECOMPOSITION SYSTEM AND METHODS OF IMPLEMENTING THE SAME

(71) Applicant: Fela AKINSE, Louisville, KY (US)

(72) Inventor: Fela AKINSE, Louisville, KY (US)

(21) Appl. No.: 18/990,613

(22) Filed: Dec. 20, 2024

(51) Int. Cl. B01D 53/62; A43B 13/02; B01D 53/82; C01B 13/02; C01D 7/00

(52) U.S. Cl. CPC B01D 53/62; A43B 13/02; B01D 53/82; C01B 13/0203; C01D 7/00; B01D 2251/306; B01D 2251/602; B01D 2253/102; B01D 2257/504; B01D 2258/06

(57) ABSTRACT

The present invention provides embodiments of a shoe sole for capturing CO2 and converting it to O2, comprising at least one sorbent configured for adsorbing CO2 from an intake air provided to at least one sorbent zone comprising the at least one sorbent, wherein the at least one sorbent comprises at least one surface configured for converting the adsorbed CO2 to O2; a plurality of air intake means configured for providing the at least one sorbent zone with the intake air comprising CO2; a plurality of air outlet means configured for evacuating an outlet air from the at least one sorbent zone, wherein the outlet air comprises less CO2 by concentration than the intake air; at least one first one-way valve configured for regulating a flow of the intake air from the air intake means to the at least one sorbent zone; and, at least one second one-way valve further configured for regulating a flow of the outlet air from the at least one sorbent zone to the air outlet means.

### TECHNICAL FIELD

The present invention relates to a wearable apparatus for CO2 adsorption and decomposition, and methods of implementing the same.

### BACKGROUND

Wearable systems for CO2 adsorption are known in the art. For example, and without limitation, wearable systems for CO2 adsorption are disclosed in PCT Patent Application No. PCT/IB2022/062581 and Korean Patent No. KR101032519B1 the disclosures of which are all hereby incorporated herein by reference in their entireties.

As discussed and/or shown in one or more of the above patent documents, existing wearable CO2 adsorption systems are typically integrated into a shoe and/or shoe sole. For example, Korean Patent No. KR101032519B1 discloses an oxygen-generating shoe, however, the oxygen generated is directed towards the foot for the purpose of improving foot hygiene and consequently is not directed towards the outside air.

PCT Patent Application No. PCT/IB2022/062581 discloses a shoe comprising a plurality of tubes extending through the shoe from its upper body to its sole, wherein an upper extremity of each of the tubes is configured to intake CO2 from an atmosphere surrounding the shoe and a lower extremity of each of the tubes is configured to evacuate O2 produced inside of the same tube.

However, the existing technologies either use materials which are not optimal because they must be replaced frequently, or which do not stand up to the wear and tear of everyday use in shoes, or are not designed with optimum efficiency in mind. For example, the use of a long, flexible tube running from an upper part of a shoe all the way down to the sole of the shoe as in PCT Patent Application No. PCT/IB2022/062581 necessitates an extremely robust tube along the whole length of the tube, since the tube must stand up to the constant pressure changes induced by a person walking or running.

The technology described in PCT Patent Application No. PCT/IB2022/062581 additionally utilizes zeolite for the conversion of CO2, necessitating light or electricity to drive photocatalytic or electrocatalytic reactions to transform CO2 into other substances.

In addition, existing technologies require the design of an entire shoe to be modified rather than focusing on a single part of a shoe, limiting the capability for modular designs and limiting the kinds of shoes that would be suitable for CO2 capture using existing technology.

Existing technologies do not separate the intake of CO2 or ambient air from the oxygen-generating reaction. In addition, these systems suffer collectively from a lack of implementation, due to their being impractical for example due to a lack of modular design as mentioned above.

An improved system for wearable CO2 capture is therefore desired.

An aim of the present invention is to address the critical need to mitigate atmospheric carbon dioxide (CO2) levels, which have risen significantly due to human activities such as fossil fuel combustion, deforestation, and industrial processes. Elevated CO2 concentrations contribute to global warming, with cascading effects such as extreme weather, rising sea levels, and ecological imbalance.

A further aim of the present invention is to provide a wearable environmental technology that also provides a scalable and practical solution applicable in diverse fields, including aerospace and automotive industries, where lightweight and portable CO2 management systems are critical.

A further aim of the present invention is to provide a wearable CO2 capture system that does not require the use of external catalysts to drive the CO2 conversion.

A further aim of the present invention is to improve the efficiency and robustness of existing wearable CO2 capture systems, for example to capture more CO2 in the same amount of time and to require less frequent maintenance of the wearable system.

### SUMMARY

The present invention addresses the drawbacks of the prior art by providing a novel approach to reducing a carbon footprint of a wearer while simultaneously producing oxygen by integrating sorbents, for example graphene-based sorbents, with potassium superoxide (KO2) in a pressure-driven system embedded within footwear.

The integration of graphene-based sorbents with potassium superoxide (KO2) in a pressure-driven system embedded within footwear offers a novel approach to reducing the wearer's carbon footprint while simultaneously producing oxygen.

According to a first aspect of the invention, a shoe sole for capturing CO2 and converting it to O2 is provided. The shoe sole comprises at least one sorbent configured for adsorbing CO2 from an intake air provided to at least one sorbent zone comprising the at least one sorbent, wherein the at least one sorbent comprises at least one surface configured for converting the adsorbed CO2 to O2; a plurality of air intake means configured for providing the at least one sorbent zone with the intake air comprising CO2; and a plurality of air outlet means configured for evacuating an outlet air from the at least one sorbent zone, wherein the outlet air comprises less CO2 by concentration than the intake air; at least one first one-way valve configured for regulating a flow of the intake air from the air intake means to the at least one sorbent zone; and, at least one second one-way valve further configured for regulating a flow of the outlet air from the at least one sorbent zone to the air outlet means.

According to another optional embodiment of the invention, the at least one sorbent may comprise graphene.

According to another optional embodiment of the invention, the at least one sorbent may be doped with nitrogen or other functional groups to enhance CO2 adsorption efficiency.

In yet another optional embodiment of the invention, the at least one sorbent zone comprising the sorbent is a chamber embedded in the shoe sole.

According to another optional embodiment of the invention, the plurality of air intake means may comprise a plurality of intake tubes embedded in the shoe sole, wherein each of the intake tubes comprises an outer extremity and an inner extremity, the outer extremity located on a periphery of a front facing portion of the shoe sole, and the inner extremity located inside the shoe sole and connected to the at least one first one-way valve.

A space inside of each of the plurality of intake tubes may be configured to periodically oscillate between an air pressure lower than atmospheric pressure and an air pressure higher than atmospheric pressure when rhythmic pressure changes are applied to a front surface of the shoe sole, for example, when a wearer of a shoe comprising the shoe sole walks.

According to another embodiment of the invention, the plurality of air outlet means may comprise a plurality of outlet tubes embedded in the shoe sole, wherein each of the outlet tubes comprises an inner extremity and an outer extremity, the inner extremity located inside the shoe sole and connected to the at least one second one-way valve, and the outer extremity located on a periphery of a rear facing portion of the shoe sole.

A space inside of each of the plurality of outlet tubes may be configured to periodically oscillate between an air pressure lower than atmospheric pressure and an air pressure higher than atmospheric pressure when rhythmic pressure changes are applied to a rear surface of the shoe sole, for example, when a wearer of a shoe comprising the shoe sole walks.

According to another embodiment of the invention, the at least one sorbent zone may comprise KO2, and the adsorbed CO2 of the sorbent may be configured to react with the KO2 at the least one surface of the at least one sorbent to produce K2CO3 and O2 gas.

In a second aspect of the invention, another shoe sole for capturing CO2 and generating O2 is provided, wherein the shoe sole comprises at least one sorbent configured for adsorbing CO2 from an intake air provided to at least one sorbent zone comprising the at least one sorbent; at least one CO2 decomposition chamber configured for receiving a desorbed CO2 from the at least one sorbent zone and for converting the desorbed CO2 to O2; a plurality of air intake means configured for providing the at least one sorbent zone with the intake air comprising CO2; at least one air outlet means configured for evacuating an outlet air from the at least one CO2 decomposition chamber, wherein the outlet air comprises less CO2 by concentration than the intake air; a plurality of first one-way valves configured for regulating a flow of the intake air from the air intake means to the at least one sorbent zone; at least one manual valve configured regulating a flow of an intermediate air comprising the desorbed CO2 from the at least one sorbent zone to the CO2 decomposition chamber.

In an optional embodiment of the second aspect, the at least one CO2 decomposition chamber comprises a replaceable KO2 cartridge.

In another optional embodiment, the at least one sorbent zone may employ a Freundlich isotherm adsorption model for adsorbing CO2.

In a third aspect of the invention, a shoe comprising a shoe sole as disclosed in embodiments of the present invention is provided.

In a fourth aspect of the invention, a method for capturing CO2 and generating O2 using a shoe sole according to the first aspect of the invention, comprising: providing an intake air to at least one sorbent zone comprising at least one sorbent configured for adsorbing CO2 from the intake air; providing at least one surface of the at least one sorbent configured for converting the adsorbed CO2 to O2; evacuating an outlet air from the at least one sorbent zone, wherein the outlet air comprises less CO2 by concentration than the intake air.

In a fifth aspect of the invention, a method for capturing CO2 and generating O2 using a shoe sole according to a second aspect of the invention is provided, comprising: providing an intake air to at least one sorbent zone comprising at least one sorbent configured for adsorbing CO2 from the intake air; providing an intermediate air comprising a portion of a desorbed CO2 from the at least one sorbent zone to a CO2 decomposition chamber configured for converting the adsorbed CO2 to O2; evacuating an outlet air from the CO2 decomposition chamber, wherein the outlet air comprises less CO2 by concentration than the intake air.

### BRIEF DESCRIPTION OF THE FIGURES

FIG. 1 is a detailed isometric view of a CO2 adsorption and decomposition system in a shoe sole according to an example embodiment.

FIG. 2 is a detailed top view of a CO2 adsorption and decomposition system in a shoe sole according to an example embodiment.

FIG. 3 is a simplified bottom isometric view of a CO2 adsorption and decomposition system in a shoe sole according to an example embodiment.

FIG. 4 is a detailed bottom isometric view of a CO2 adsorption and decomposition system in a shoe sole according to an example embodiment.

FIG. 5 is a front view of air intake means of a CO2 adsorption and decomposition system in a shoe according to an example embodiment.

FIG. 6 is a side view of air intake means and air outlet means of a CO2 adsorption and decomposition system in a shoe sole according to an example embodiment.

FIG. 7 is a simplified top view of a shoe sole comprising a CO2 adsorption and decomposition system according to an example embodiment.

FIG. 8 is a further simplified bottom view of the sole of a shoe comprising a CO2 adsorption and decomposition system according to an example embodiment.

FIG. 9 is an isometric view demonstrating a main chemical reaction of a CO2 adsorption and decomposition system according to an example embodiment.

FIG. 10 is a schematic view of a compression of a tube of a CO2 adsorption and decomposition system according to an example embodiment.

FIG. 11 is a schematic step-by-step view of a compression of a tube of a CO2 adsorption and decomposition system according to an example embodiment.

FIG. 12 is a detailed isometric view of a dual-chamber CO2 adsorption and decomposition system in a shoe sole according to an example embodiment.

FIG. 13 is a simplified isometric view of a dual-chamber CO2 adsorption and decomposition system in a shoe sole according to an example embodiment.

FIG. 14 is a side view showing air intake means and air outlet means in a shoe sole comprising a dual-chamber CO2 adsorption and decomposition system according to an example embodiment.

FIG. 15 is a front view showing air intake means in a shoe sole comprising a dual-chamber CO2 adsorption and decomposition system according to an example embodiment.

FIG. 16 is a detailed top view of a dual-chamber CO2 adsorption and decomposition system in a shoe sole according to an example embodiment.

FIG. 17 is an isometric view demonstrating a main chemical reaction occurring in a dual-chamber CO2 adsorption and decomposition system according to an example embodiment.

FIG. 18 provides a table summarizing CO2 removal and O2 generation in a simulation of the CO2 adsorption and decomposition system in a shoe sole according to example embodiments of the invention.

FIG. 19 provides a summary of the cumulative amounts of CO2 captured and O2 generated over the lifetime of the CO2 adsorption and decomposition system in a shoe sole according to embodiments of invention, as well as the total time required for KO2 to be fully consumed.

FIG. 20 illustrates a first flowchart according to an example embodiment.

FIG. 21 illustrates a second flowchart according to an example embodiment.

These and/or other aspects, features, and/or advantages will become apparent and more readily appreciated from the following description of various example embodiments, taken in conjunction with the accompanying drawings. Thicknesses of layers/elements, and sizes of components/elements, are not necessarily drawn to scale or in actual proportion to one another but rather are shown as example representations. Like reference numerals may refer to like parts throughout the several views. Each embodiment herein may be used in combination with any other embodiment(s) described herein.

### DETAILED DESCRIPTION

The following detailed structural and/or functional description(s) is/are provided as examples only, and various alterations and modifications may be made. The example embodiments herein do not limit the disclosure and should be understood to include all changes, equivalents, and replacements within ideas and the technical scope herein. Hereinafter, certain examples will be described in detail with reference to the accompanying drawings. When describing various example embodiments with reference to the accompanying drawings, like reference numerals may refer to like components and a repeated description related thereto may be omitted.

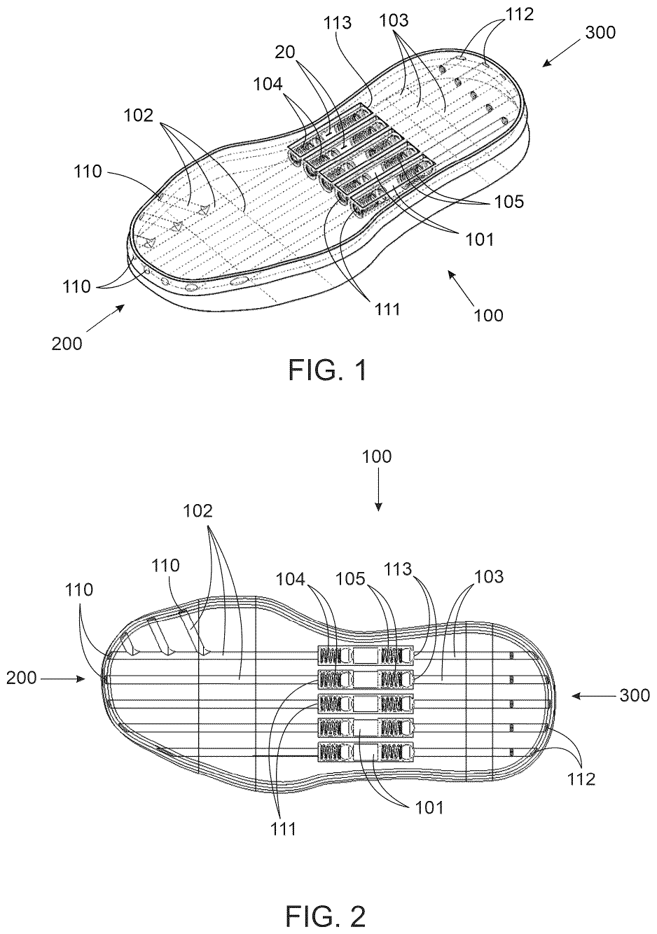

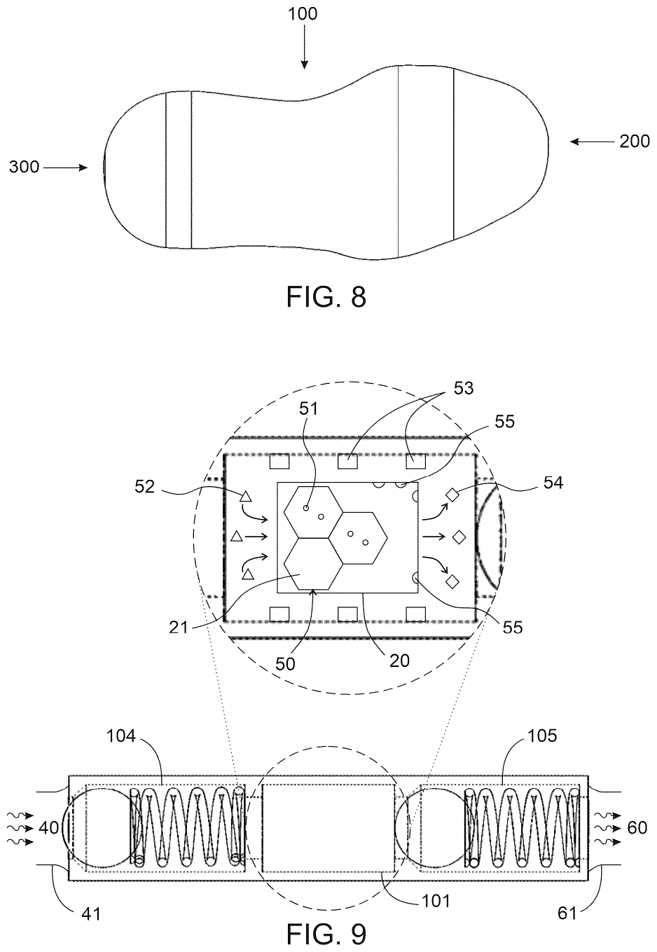

Parts of the shoe sole 100 according to embodiments of the invention is represented in FIGS. 1-11. In a first aspect of the invention represented according to an embodiment in FIG. 9, the shoe sole 100 (sole not shown in FIG. 9) comprises at least one sorbent 20, a plurality of air intake means 41, a plurality of air outlet means 61, at least one first one-way valve 104, and at least one second one-way valve 105.

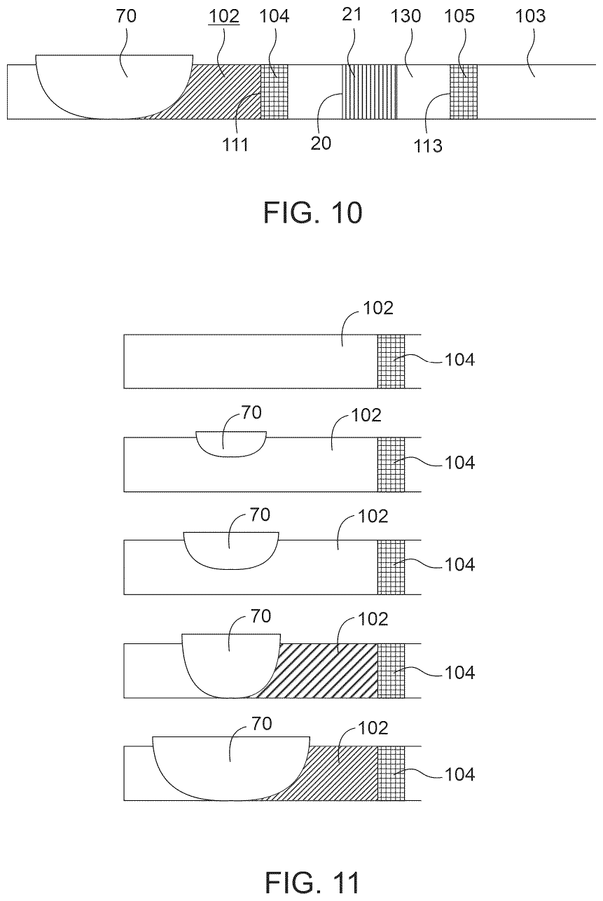

As can be seen according to the example embodiment of the invention shown in FIG. 9, the at least one sorbent 20 is configured for adsorbing CO2 52 from an intake air 40 provided to at least one sorbent zone 101 comprising the at least one sorbent 20, wherein the at least one sorbent 20 comprises at least one surface 21, for example the surface 21 shown according to an example embodiment of the invention in FIGS. 9 and 10, wherein the surface 21 is configured for converting the adsorbed CO2 52 to O2 54.

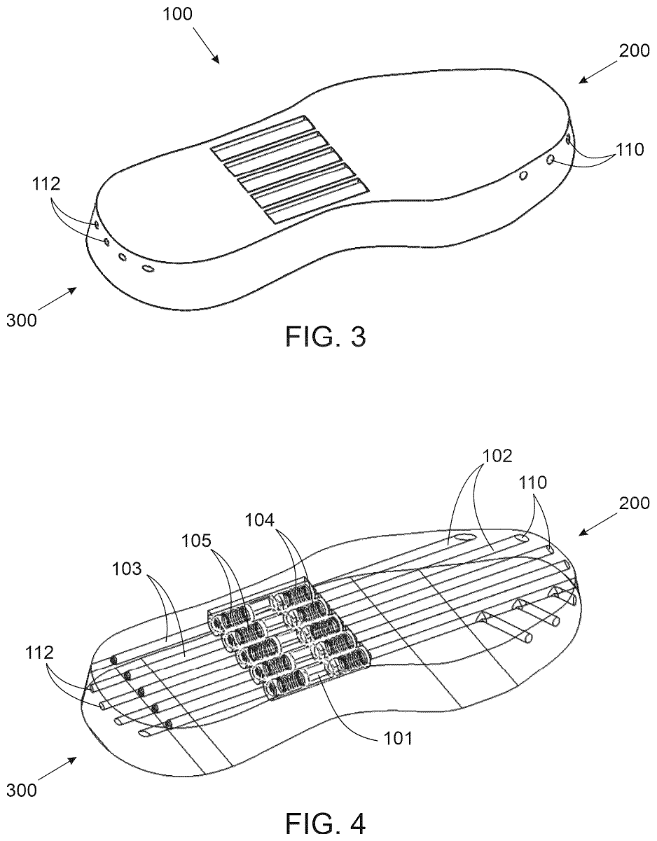

As seen in embodiments of the invention shown in FIGS. 1, 2, and 4, the air intake means 41 may comprise, for example, a plurality of inlet tubes 102 embedded in the shoe sole 100 and wherein a longitudinal axis of each of the plurality of inlet tubes 102 is substantially parallel to a plane of the shoe sole, and wherein each of the inlet tubes 102 comprises an outer extremity 110 and an inner extremity 111, the outer extremity 110 located on a periphery of a front facing portion 200 of the shoe sole 100, and the inner extremity 111 located inside the shoe sole 100 and connected to a plurality of first one-way valves 104, as shown further according to embodiments of the invention in FIGS. 3, 5, and 6-8.

According to embodiments of the invention shown in FIGS. 1, 2, and 4, the shoe sole 100 may comprise a plurality of sorbent zones 101, for example five sorbent zones arranged one next to the other and embedded in the shoe sole 100. Other numbers of sorbent zones are possible and may be adapted accordingly for different shoe sizes.

According to embodiments of the invention, the sorbent 20 may comprise, for example, a material configured for adsorbing CO2 52, for example graphene 50 as shown in FIG. 9. The sorbent 20, for example, the graphene 50, may be doped with a functional group to enhance CO2 adsorption efficiency, for example, a graphene sorbent 50 may be doped with nitrogen 51 to enhance a CO2 adsorption efficiency of a surface 21 of the graphene sorbent 50. As shown in FIG. 9, the at least one sorbent zone 101 may comprise potassium superoxide (KO2) molecules 53, for example, the graphene 50 may be doped with KO2 molecules 53.

The structure of graphene 50 provides a high surface area, conferring it the most efficient CO2 capture in terms of volume and weight. It is also durable and lightweight, so is suited to wearable technologies.

FIG. 9 schematically illustrates an example of the at least one sorbent 20 configured for converting the adsorbed CO2 52 to O2 54, via a chemical reaction occurring in the at least one sorbent zone 101 (only one sorbent zone 101 shown according to the embodiment of FIG. 9) or on the surface 21 of the sorbent 20, for example on a surface 21 of the graphene 50. In this example embodiment of the invention, the potassium superoxide KO2 molecules 53 present in the at least one sorbent zone 101 react with CO2 52 adsorbed by the graphene 50, wherein the CO2 52 is provided to the at least one sorbent zone 101 by the air intake means 41, to produce potassium carbonate K2CO3 55, which is a harmless potassium salt that is deliquescent, i.e., melts easily, and is soluble in water, therefore can be easily washed, and gaseous oxygen O2 54:

4KO2+CO2→2K2CO3+3O2

According to an embodiment of the invention illustrated in FIG. 9, the shoe sole (shoe sole not shown in FIG. 9) further comprises a plurality of air outlet means 61 configured for evacuating an outlet air from the at least one sorbent zone 101, wherein the outlet air 60 comprises less CO2 52 by concentration than the intake air 40.

As shown according to embodiments of the invention in FIGS. 1, 2, and 4, the plurality of air outlet means 61 may comprise, for example, a plurality of outlet tubes 103 embedded in the shoe sole and wherein a longitudinal axis of each of the plurality of outlet tubes 103 is substantially parallel to a plane of the shoe sole, wherein each of the outlet tubes 103 comprises an inner extremity 113 and an outer extremity 112, the inner extremity 113 located inside the shoe sole and connected to the plurality of air outlet means 103 via a plurality of second one-way valves 105, and the outer extremity 112 located on a periphery of a rear facing portion 300 of the shoe sole 100, as further shown in FIGS. 3 and 6-8.

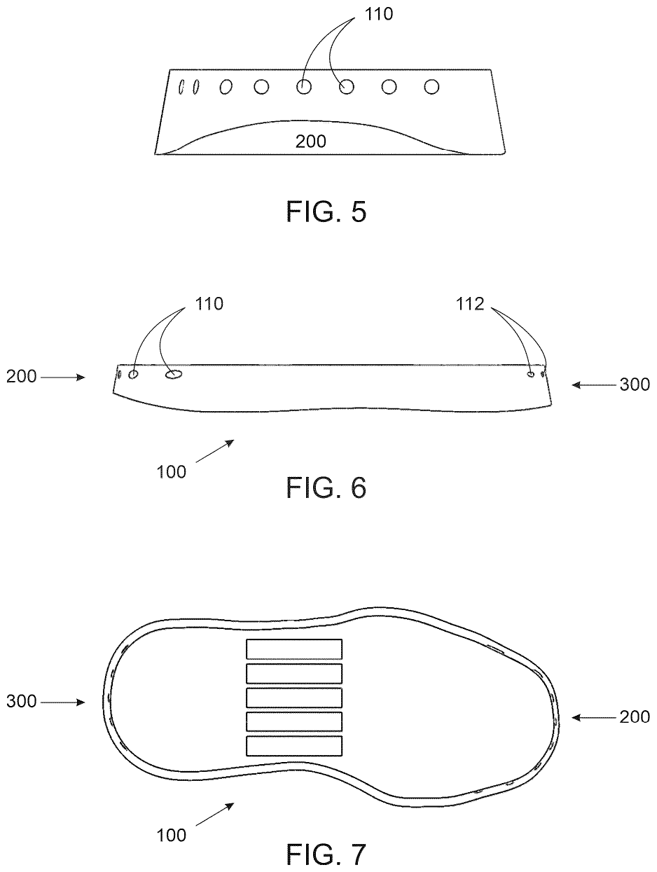

FIG. 5 is a front view of an example shoe sole showing an outer extremity 110 of a plurality of air intake tubes 102 located on a periphery of a front facing portion 200 of the example shoe sole, and FIG. 6 is a side view of an example shoe sole 100 showing an outer extremity 110 of a plurality of air intake tubes 102 and an outer extremity 112 located on a periphery of a rear facing portion 300 of the example shoe sole 100 of each of a plurality of air outlet tubes 103 (air intake and air outlet tubes not shown).

As can be seen according to example embodiments in FIG. 9, the gaseous O2 molecules 54 produced at a surface 21 of the sorbent 20 or of the graphene 50 pass through a plurality of second one-way valves 105 through the air outlet means 61 in an outlet air 60 comprising less CO2 by concentration than the intake air 40, since the CO2 52 provided to the at least one sorbent zone 101 by the plurality of air intake means 41 may be adsorbed by a sorbent 20 and may react with KO2 molecules 53 at a surface 21 of the sorbent to produce K2CO3 55 and oxygen 54.

A movement or a flow of intake air 40 through the air intake means 41 to the at least one sorbent zone 101 may be regulated by pressure changes of the air intake means 41 induced by a human wearer of a shoe comprising the shoe sole 100 according to embodiments of the invention, as well as by a plurality of first one-way valves 104.

For example, referring to FIG. 1, an intake air 40 (not shown in FIG. 1) may be sucked inside the plurality of intake tubes 102 if an air pressure inside each of the plurality of intake tubes 102 is less than atmospheric pressure, for example when a wearer's foot releases pressure on a front part of a shoe sole 100 installed in a shoe (wearer's foot and shoe not shown in FIG. 1), such as at the end of a forefoot strike. The intake air 40 may then pass through the plurality of intake tubes 102 and be pushed into a plurality of first one-way valves 104 and into the at least one sorbent zone 101, delivering the at least one sorbent zone 101 with intake air 40 comprising CO2.

For example, still referring to FIG. 1, the intake air 40 may pass through the plurality of first one-way valves 104 into the at least one sorbent zone 101 if an air pressure inside the at least one sorbent zone 101 is less than an air pressure inside each of the plurality of intake tubes 102, for example when a wearer's foot applies pressure on a front part of a shoe sole 100 installed in a shoe, for example at the start of and during a forefoot strike.

The plurality of first one-way valves 104 provides the advantage of ensuring unidirectional movement of air flow, contributing to optimal CO2 capture and therefore greater adsorption efficiency.

Similarly, referring to FIG. 1, a movement or a flow of outlet air from the at least one sorbent zone 101 through the plurality of outlet tubes 103 may be regulated through a similar mechanism as for the inlet air 40: by pressure changes occurring inside each of the plurality of outlet tubes 103 induced by a human wearer of a shoe (human wearer and shoe not shown in FIG. 1) comprising the shoe sole 100 according to embodiments of the invention, as well as by a plurality of second one-way valves 105.

For example, referring to FIG. 1, an outlet air 60 (outlet air not shown in FIG. 1) may be sucked out of the at least one sorbent zone 101 into the plurality of outlet tubes 103 when an air pressure inside each of the plurality of outlet tubes 103 is lower than an air pressure in the at least one sorbent zone 101, for example when a wearer's foot releases pressure on a rear part of a shoe sole 100 installed in a shoe, for example after a heel strike. The outlet air 60, comprising less CO2 by concentration than the intake air 40, may then be pushed out of the plurality of outlet tubes 103 and thus out of the shoe sole 100 when an air pressure inside each of the plurality of outlet tubes 103 is higher than atmospheric pressure, for example at the start of and during a new heel strike, when a wearer's foot applies pressure on a rear part of a shoe sole 100 installed in a shoe. The outlet air 60 cannot return into the at least one sorbent zone 101 thanks to the plurality of second one-way valves 105.

Therefore, the plurality of intake tubes 102 and the plurality of outlet tubes 103 may be designed to compress and expand rhythmically during walking, for example to compress and expand more than the at least one sorbent zone 101, enabling a continuous flow of air into the at least one sorbent zone 101. Therefore, the material used for fabricating the plurality of intake tubes 102 and the plurality of outlet tubes 103 may be less rigid or more elastic than the material used for fabricating the at least one sorbent zone 101. The plurality of intake tubes 102 and the plurality of outlet tubes 103 may for example compress and expand sufficiently to create air pressures both higher and lower than atmospheric pressure inside of each of the intake tubes 102 and inside each of the outlet tubes 103.

Each of the plurality of inlet tubes 102 and the plurality of outlet tubes 103 may be made of or substantially comprise a material that compresses considerably under typical foot plantar pressures applied to the shoe sole 100 installed in a shoe as a human wearer of the shoe walks, for example, under plantar pressures of 50 to 300 kPa. The material used for the fabrication of the plurality of intake tubes 102 and the plurality of outlet tubes 103 may comprise, for example, a thermoplastic elastomer (TPE) or a thermoplastic polyurethane (TPU) or silicone.

The at least one sorbent zone 101 may substantially comprise a chamber made of a more rigid material than the material used for the plurality of intake tubes 102 and the outlet tubes 103, for example a hard plastic such as polypropylene. Other example materials for the at least one sorbent zone 101 comprise polyether ether ketone, carbon fibre-reinforced polymer, or glass-field nylon.

The plurality of first one-way valves 104 and the plurality of second one-way valves 105 may comprise, for example, check valves, for example check valves with springs, configured to allow the flow of fluids, for example, an intake air 40 or an outlet air 60, in a single direction only.

Referring to FIG. 10, a demonstration of a deformable inlet tube 102 pressed on by a heel bone 70 is shown. Pressure inside the inlet tube 102 increases, and a one-way valve 104 between the tube 102 and the at least one sorbent zone 101 (sorbent zone 101 not shown in FIG. 10) opens due to a higher pressure zone inside the tube 102 versus the at least one sorbent zone 101. The at least one sorbent zone 101 then receives air from the inlet tube 102 and releases air through a second one-way valve in the plurality of one-way valves 105 when a pressure inside the at least one sorbent zone 101 exceeds a pressure inside an outlet tube 103.

Referring to FIG. 11, a step-by-step demonstration of compression of one of a plurality of inlet tubes 102 is demonstrated by simplified representation of a heel bone 70 in FIG. 11. As the heel bone 70 applies pressure to a shoe sole 100 comprising the inlet tube, the tube undergoes mechanical deformation and a pressure inside of the tube is increased, with increased pressure indicated by diagonal lines increasingly close together.

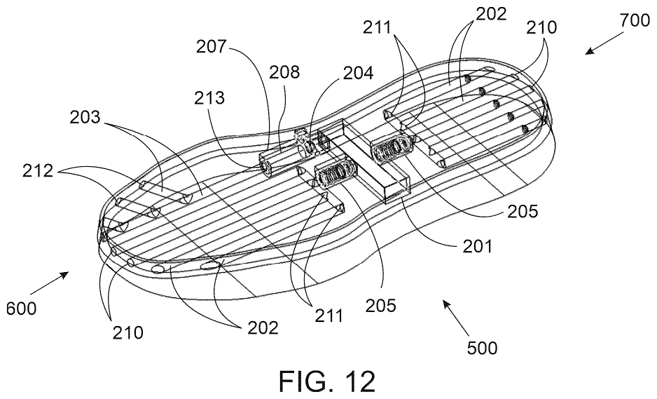

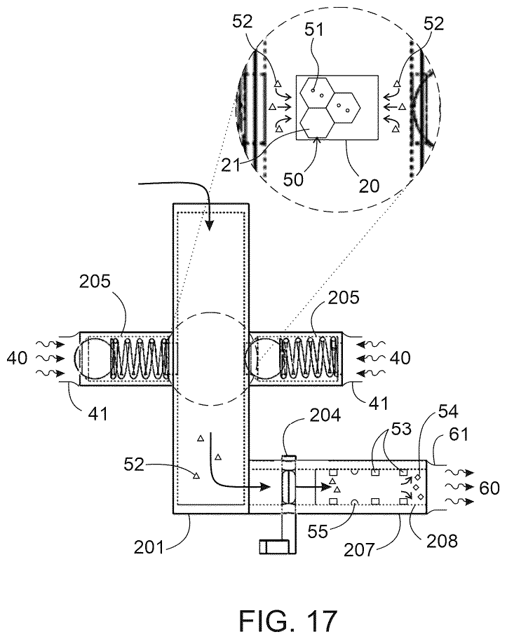

A shoe sole 500 according to embodiments of the invention is represented in FIGS. 12-17. In a second aspect of the invention represented according to an embodiment in FIG. 17, the shoe sole 500 (shoe sole not shown in FIG. 17) comprises at least one sorbent 20, at least one CO2 decomposition chamber 207, a plurality of air intake means 41, at least one air outlet means 61, a plurality of first one-way valves 205, and at least one manual valve 204.

According to an embodiment of the invention shown in FIG. 17, the at least one sorbent 20 is configured for adsorbing CO2 from an intake air 40 provided to at least one sorbent zone 201 comprising the at least one sorbent 20. In addition, the at least one CO2 decomposition chamber 207 is configured for receiving the adsorbed CO2 52 from the at least one sorbent zone 201 and for converting the adsorbed CO2 to O2. The CO2 decomposition chamber may comprise a replaceable KO2 cartridge 208 for easy and accessible maintenance.

As shown in FIG. 17, the plurality of air intake means 41 are configured for providing the at least one sorbent zone 201 with the intake air 40 comprising CO2, and the at least one air outlet means 61 are configured for evacuating an outlet air 60 from the at least one CO2 decomposition chamber 207, wherein the outlet air 60 comprises less CO2 by concentration than the intake air 40.

The at least one manual valve 204 is configured for regulating a flow of air comprising a desorbed CO2 52 from the at least one sorbent zone 201 to the CO2 decomposition chamber 207; and the plurality of first one way valves 205 are configured for regulating a flow of the intake air 40 from the air intake means 41 to the at least one sorbent zone 201.

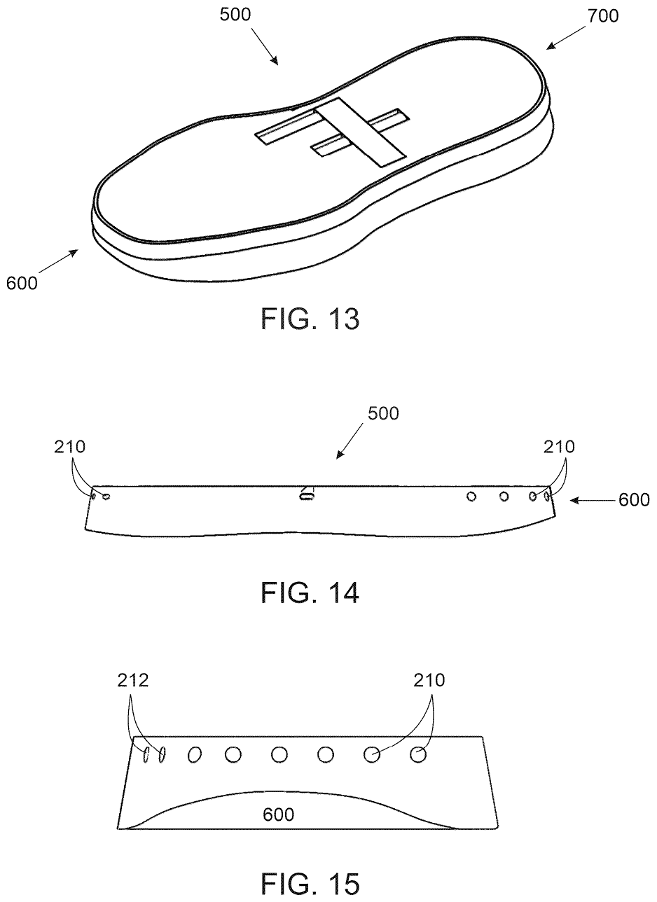

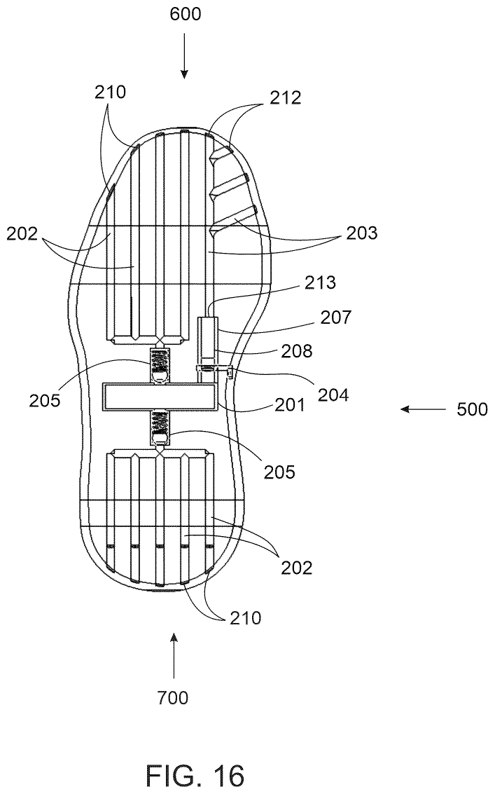

According to embodiments of the invention shown in FIGS. 12 and 16, the plurality of air intake means 41 (air intake means 41 not shown in FIG. 16) may comprise, for example, a plurality of intake tubes 202 embedded in the shoe sole 500 and each having a longitudinal axis substantially parallel to a plane of the shoe sole, wherein each of the intake tubes comprises an outer extremity 210 and an inner extremity 211, the outer extremity 210 for each tube located either on a periphery of a front facing portion 600 of the shoe sole 500 or on a periphery of a rear facing portion 700 of the shoe sole 500, and the inner extremity 211 located inside the shoe sole 500 and connected directly to the at least one sorbent zone 201 via a plurality of first one-way valves 205, as further shown in FIGS. 13-15.

According to embodiments of the invention, the sorbent 20 may comprise, for example, a material configured for adsorbing CO2 52, for example graphene 50 as shown in FIG. 17. The sorbent 20, for example, the graphene 50, may be doped with a functional group to enhance CO2 adsorption efficiency, for example, a graphene sorbent 50 may be doped with nitrogen 51 to enhance a CO2 adsorption efficiency of a surface 21 of the graphene sorbent 50.

FIG. 17 illustrates an example of the at least CO2 decomposition chamber 207 configured for converting adsorbed CO2 to O2, via a chemical reaction occurring in the CO2 decomposition chamber. In this example embodiment of the invention, potassium superoxide KO2 molecules present in the CO2 decomposition chamber 207 from KO2 cartridge 208 react with CO2 to produce potassium carbonate K2CO3 55, which is a harmless potassium salt that is deliquescent, i.e., melts easily, and is soluble in water, therefore can be easily washed, and gaseous oxygen O2 54:

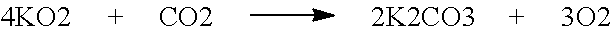

According to an embodiment of the invention illustrated in FIG. 17, the shoe sole (shoe sole not shown in FIG. 9) further comprises a plurality of air outlet means 61 configured for evacuating an outlet air 60 from the CO2 decomposition chamber 207, wherein the outlet air 60 comprises less CO2 by concentration that the intake air 40.

Additionally, as shown in FIGS. 12 and 16, the plurality of air outlet means 61 may comprise a plurality of outlet tubes 203 embedded in the shoe sole 500 and each having a longitudinal axis substantially parallel to a plane of the shoe sole, wherein each of the outlet tubes 203 comprises an inner extremity 213 and an outer extremity 212, the inner extremity 213 located inside the shoe sole and connected to the CO2 decomposition chamber 207, and the outer extremity 212 located on a periphery of a front facing portion 600 of the shoe sole 500, as further shown in FIG. 15.

A movement or a flow of intake air 40 through the air intake means 41 to the at least one sorbent zone 201 may be regulated by pressure changes of the air intake means 41 induced by a human wearer of a shoe comprising the shoe sole 500 according to embodiments of the invention.

For example, referring to FIG. 12, the at least one sorbent zone 201 may comprise a sorbent 20, for example graphene 50, with a high affinity for CO2 under pressure. The at least one sorbent zone remains pressurized via the plurality of one-way valves 205 on both sides of the at least one sorbent zone 201, allowing the at least one sorbent zone 201 to store CO2 at a high pressure during each step a wearer takes (wearer and step not shown in FIG. 12).

An elevated pressure, for example a pressure higher than atmospheric pressure inside the at least one sorbent zone 201, increases the adsorption rate of CO2 into the sorbent 20, for example the graphene 50, allowing the sorbent 20 to capture CO2 more efficiently during movement. The plurality of one-way valves 205 ensure that intake air 40 flows into the at least one sorbent zone 201 only when needed, while preventing reverse flow, maintaining high pressure.

The CO2 decomposition chamber 207 is connected to the at least one sorbent zone 201 through a manually controlled valve 204. A wearer may open the valve 204 when the wearer is stationary, causing desorbed CO2 52 from the graphene 50 or the sorbent 20 to flow into the CO2 decomposition chamber 207, where it may react with KO2 molecules 53 to produce K2CO3 molecules 55 and O2 54. The O2 54 may then be released from the CO2 decomposition chamber 207 in the outlet air 60 via the air outlet means 61.

In summary, referring to FIG. 12 the operating mechanism may comprise (1) pressure-driven adsorption during walking of a wearer, wherein each step of the wearer (wearer and step not shown in FIG. 12) increases an air pressure in the at least one sorbent zone 201, forcing CO2 52 into contact with the sorbent 20; (2) controlled desorption via opening of the at least one manual valve 204, releasing pressure on the sorbent 20 and allowing desorbed CO2 molecules 52 into the CO2 decomposition chamber; and (3) CO2 decomposition and O2 generation.

Therefore, the plurality of intake tubes 202 and the plurality of outlet tubes 203 may be designed to compress and expand rhythmically during walking more than the at least one sorbent zone 201, enabling a continuous flow of air into the at least one sorbent zone 201, for example to compress and expand sufficiently to create air pressures both higher and lower than atmospheric pressure inside of each of the intake tubes 202 and inside each of the outlet tubes 203.

FIG. 15 is a front view of an example shoe sole showing outer extremities 210 of a plurality of air intake tubes 202 and an outer extremity 212 of one of a plurality of air outlet tubes 203 located on a periphery of a front facing portion 600 of the example shoe sole, and FIG. 14 is a side view of an example shoe sole 500 showing outer extremities 210 of a plurality of air intake tubes 202 (air intake 202 and air outlet tubes 203 not shown).

Each of the plurality of inlet tubes 202 and the plurality of outlet tubes 203 may be made of or substantially comprise a material that compresses considerably under typical foot plantar pressures applied to the shoe sole 500 installed in a shoe as a human wearer of the shoe walks, for example, under plantar pressures of 50 to 300 kPa. The material used for the fabrication of the plurality of intake tubes 202 and the plurality of outlet tubes 203 may comprise, for example, a thermoplastic elastomer (TPE) or a thermoplastic polyurethane (TPU) or silicone.

The plurality of first one-way valves 205 may comprise, for example, check valves, for example check valves with springs, configured to allow the flow of fluids, for example, an intake air 40, in a single direction only. The at least one manual valve 204 may comprise, for example, a ball valve.

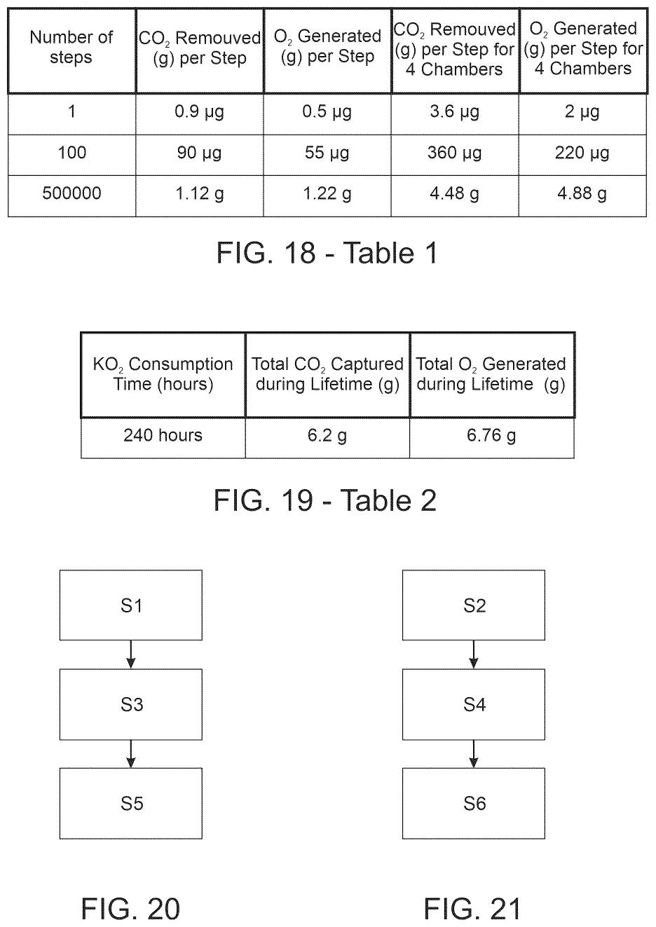

The tables of FIGS. 18 and 19 summarize the simulation results for CO₂ removal and O₂ generation in shoe soles 100 and 500 according to embodiments designed to capture CO₂ from air and produce O₂ over time for one shoe. according to two embodiments of the first aspect of the invention, one comprising one sorbent zone and one comprising four sorbent zones.

The tables record the amount of CO₂ removed per step and the O2 generated per step, according to two embodiments of the first aspect of the invention, one comprising one sorbent zone and one comprising four sorbent zones (embodiments not shown).

Additionally, the table of FIG. 19 includes the total time required for KO₂ to be fully consumed, as well as the cumulative amounts of CO₂ captured and O2 generated over the lifetime of the system. This data provides insight into the efficiency and capacity of the system under different configurations.

A method for capturing CO2 and generating O2 using a shoe sole 100 according to embodiments of the invention is shown in FIG. 20, comprising: providing an intake air to at least one sorbent zone comprising at least one sorbent configured for adsorbing CO2 from the intake air (S1); providing at least one surface of the at least one sorbent configured for converting the adsorbed CO2 to O2 (S3); evacuating an outlet air from the at least one sorbent zone, wherein the outlet air comprises less CO2 by concentration than the intake air (S5).

A method for capturing CO2 and generating O2 using a shoe sole 500 according to embodiments of the invention is shown in FIG. 21, comprising: providing an intake air to at least one sorbent zone comprising at least one sorbent configured for adsorbing CO2 from the intake air (S2); providing an intermediate air comprising a portion of a desorbed CO2 from the at least one sorbent zone to a CO2 decomposition chamber configured for converting the adsorbed CO2 to O2 (S4); evacuating an outlet air from the CO2 decomposition chamber, wherein the outlet air comprises less CO2 by concentration than the intake air (S6).

According to embodiments of the invention, a monitoring system configured to measure a rate of CO2 adsorption and a rate of O2 production of a shoe sole 100 or 500 according to embodiments of the invention may be provided. The monitoring system may comprise a mobile application running on a mobile device and configured to communicate with sensors placed in a shoe sole 100 or 500, for example via wireless communication, and configured for example to measure KO2 reserves, which may be used for example to calculate a rate of CO2 adsorption and a rate of O2 production.

Each embodiment herein may be used in combination with any other embodiment(s) described herein. While the disclosure has been illustrated and described with reference to various example embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in combination with any other embodiment(s) described herein.

1. A shoe sole for capturing CO2 and converting it to O2, wherein the shoe sole comprises:
at least one sorbent configured for adsorbing CO2 from an intake air provided to at least one sorbent zone comprising the at least one sorbent, wherein the at least one sorbent comprises at least one surface configured for converting the adsorbed CO2 to O2;
a plurality of air intake means configured for providing the at least one sorbent zone with the intake air comprising CO2;
a plurality of air outlet means configured for evacuating an outlet air from the at least one sorbent zone, wherein the outlet air comprises less CO2 by concentration than the intake air;
at least one first one-way valve configured for regulating a flow of the intake air from the air intake means to the at least one sorbent zone; and,
at least one second one-way valve further configured for regulating a flow of the outlet air from the at least one sorbent zone to the air outlet means.

2. The shoe sole according to claim 1, wherein the at least one sorbent comprises graphene.

3. The shoe sole according to claim 1, wherein the at least one sorbent is further doped with nitrogen or other functional groups to enhance CO2 adsorption efficiency.

4. The shoe sole according to claim 1, wherein the at least one sorbent zone comprising the sorbent is a chamber embedded in the shoe sole.

5. The shoe sole according to claim 1, wherein the plurality of air intake means comprise a plurality of intake tubes embedded in the shoe sole, wherein each of the intake tubes comprises an outer extremity and an inner extremity, the outer extremity located on a periphery of a front facing portion of the shoe sole, and the inner extremity located inside the shoe sole and connected to the at least one first one-way valve.

6. The shoe sole according to the previous claim, wherein a space inside of each of the plurality of intake tubes is configured to periodically oscillate between an air pressure lower than atmospheric pressure and an air pressure higher than atmospheric pressure when rhythmic pressure changes are applied to a front surface of the shoe sole, for example, when a wearer of a shoe comprising the shoe sole walks.

7. The shoe sole according to claim 1, wherein the plurality of air outlet means comprise a plurality of outlet tubes embedded in the shoe sole, wherein each of the outlet tubes comprises an inner extremity and an outer extremity, the inner extremity located inside the shoe sole and connected to the at least one second one-way valve, and the outer extremity located on a periphery of a rear facing portion of the shoe sole.

8. The shoe sole according to the previous claim, wherein a space inside of each of the plurality of outlet tubes is configured to periodically oscillate between an air pressure lower than atmospheric pressure and an air pressure higher than atmospheric pressure when rhythmic pressure changes are applied to a rear surface of the shoe sole, for example, when a wearer of a shoe comprising the shoe sole walks.

9. The shoe sole according to claim 1, wherein the at least one sorbent zone comprises KO2, and the adsorbed CO2 of the sorbent is configured to react with the KO2 at the least one surface of the at least one sorbent to produce K2CO3 and O2 gas.

10. A shoe sole for capturing CO2 and generating O2, wherein the shoe sole comprises:
at least one sorbent configured for adsorbing CO2 from an intake air provided to at least one sorbent zone comprising the at least one sorbent;
at least one CO2 decomposition chamber configured for receiving a desorbed CO2 from the at least one sorbent zone and for converting the desorbed CO2 to O2;
a plurality of air intake means configured for providing the at least one sorbent zone with the intake air comprising CO2;
at least one air outlet means configured for evacuating an outlet air from the at least one CO2 decomposition chamber, wherein the outlet air comprises less CO2 by concentration than the intake air;
a plurality of first one-way valves configured for regulating a flow of the intake air from the air intake means to the at least one sorbent zone;
at least one manual valve configured regulating a flow of an intermediate air comprising the desorbed CO2 from the at least one sorbent zone to the CO2 decomposition chamber.

11. The shoe sole according to the previous claim, wherein the at least one CO2 decomposition chamber comprises a replaceable KO2 cartridge.

12. The shoe sole according to claim 11, wherein the at least one sorbent zone employs a Freundlich isotherm adsorption model for adsorbing CO2.

13. A shoe comprising the shoe sole according to any one of the previous claims.

14. A method for capturing CO2 and generating O2 using a shoe sole according to claim 1, comprising:
providing an intake air to at least one sorbent zone comprising at least one sorbent configured for adsorbing CO2 from the intake air;
providing at least one surface of the at least one sorbent configured for converting the adsorbed CO2 to O2;
evacuating an outlet air from the at least one sorbent zone, wherein the outlet air comprises less CO2 by concentration than the intake air.

15. A method for capturing CO2 and generating O2 using a shoe sole according to claim 11, comprising:
providing an intake air to at least one sorbent zone comprising at least one sorbent configured for adsorbing CO2 from the intake air;
providing an intermediate air comprising a portion of a desorbed CO2 from the at least one sorbent zone to a CO2 decomposition chamber configured for converting the adsorbed CO2 to O2;
evacuating an outlet air from the CO2 decomposition chamber, wherein the outlet air comprises less CO2 by concentration than the intake air.

16. A monitoring system configured to measure a rate of CO2 adsorption and a rate of O2 production of the shoe sole according to any one of claims 1 to 13.
